(19) United States
(12) Patent Application Publication
(10) Pub. No.: US 2003/0051613 A1
(43) Pub. Date: Mar. 20, 2003

(54) Lubrication vacuum system for a press

(76) Inventors: Edward A. Daniel, Fort Loramie, OH (US); Jill M. Bornhorst, Minster, OH (US)

Correspondence Address: RANDALL J. KNUTH P.C., 3510-A STELLHORN ROAD, FORT WAYNE, IN, 46815-4631, US

(21) Appl. No.: 10/219,330

(22) Filed: Aug. 15, 2002

Related U.S. Application Data
(60) Provisional application No. 60/312,912, filed on Aug. 16, 2001.

(51) Int. Cl. B30B 1/00

(52) U.S. Cl. 100/214

(57) ABSTRACT

A lubrication vacuum system for a press includes a vacuum operated fluid leakage collector having a first vacuum device attached to the drive piston of the press, a wiper attached to the frame of the press and in surrounding relationship with the drive piston, and a second vacuum device attached to the frame of the press and adjacent the wiper. Alternately, a third vacuum device can be added adjacent the seal. Still alternately, the first vacuum device can have an inclined slope on its top surface for directing lubrication oil to the vacuum port.

### CONTINUATION DATA

The present application hereby claims the benefit under Title 35, United States Code §119(e) of U.S. provisional application No. 60/312,912 filed Aug. 16, 2001.

### BACKGROUND OF THE INVENTION

1. Field of the Invention

This invention relates to a lubrication vacuum system for a press, and, more particularly, to a vacuum operated fluid leakage collector system that includes a vacuum device adjacent to a piston wiper and a second vacuum device secured to the piston.

2. Description of the Related Art

In machines having relatively movable parts, and particularly in certain mechanical presses having a piston which protrudes from the bottom of a crown, a flexible seal is generally carried by the crown in a surrounding and sealing relationship with the outer surface of the piston. Lubricating fluid facilitates a sliding relationship between the piston and the seal, and the seal substantially prevents the loss of the lubricating fluid from the crown which would otherwise result in the contamination of work pieces below.

Seal damage due to installation, contamination, corrosion, or seal compression can occur rapidly or gradually in a mechanical press, eventually degrading the seal's ability to retain lubricating fluid within the crown. With continued press use, seal degradation leads to fluid accumulation about the seal, and fluid eventually reaches the stamped work pieces, thus ruining the product and increasing production costs.

Accumulation of lubricating fluid about a piston is also undesirable because it reduces the amount of fluid that is available for lubricating purposes and necessitates the addition of lubricating fluid to the machine. Furthermore, it is advantageous to keep the machine exterior free from lubricating fluid so that dust and dirt do not accumulate, and to keep any other preferably dry members in the vicinity free from the fluid.

It is therefore desirable that lubricating fluid be contained within a piston housing, thereby avoiding fluid accumulation on an external portion of the piston, and it is a principle object of the present invention to provide an arrangement that accomplishes that result.

Certain prior art arrangements have addressed this issue by securing a vacuum device to the crown at a point immediately below the seal for vacuuming excess lubricating fluid from the piston when seal leakage occurs. This arrangement is disadvantageous because during operation the crown tends to be susceptible to thermal expansion, resulting in unwanted gaps between the piston and the crown-mounted vacuum, or in other cases, resulting in scores in the piston because the vacuum device expanded into the piston. Meanwhile, efficiency of the vacuum device is negatively affected by the variations in spacing between the piston and the vacuum device.

Other prior art has utilized a wiper apparatus above the seal, resulting in a pool of oil above the seal. This arrangement is disadvantageous because the oil collects above the seal and ultimately promotes excessive leakage around the seal.

### SUMMARY OF THE INVENTION

The present invention overcomes the disadvantages inherent in prior art oil control systems by providing a vacuum device secured to the piston below the piston seal and a second vacuum device and wiper combination secured above the piston seal. This arrangement is advantageous because it provides a lower concentration of oil around the piston seal, and provides a vacuum below the seal that is not susceptible to thermal expansion due to its mounting on the piston.

The present invention is directed to a lubrication vacuum system for a machine press wherein a seal is provided about the drive piston for preventing migration of lubricating oil from the press crown to the slide or to the product worked on by the press. In the invention, a first vacuum device is mounted to the piston below the seal, and a wiper apparatus is secured above the seal and proximal to a second vacuum device. The first vacuum device can also include an inclined upper surface for drawing oil into an annular opening on the vacuum device adjacent the drive piston.

Alternatively, yet a third vacuum device can be provided, the third vacuum device being positioned below the seal, and attached to the crown. The third vacuum device can be spaced from the piston to accommodate for thermal expansion because the piston-secured vacuum device will operate to remove excess oil.

An advantage of the lubrication vacuum system of the present invention is the repositioned wiper above the piston seal. The elevated position of the wiper in combination with the adjacent second vacuum device eliminates the pooling of excess oil on top of the piston seal, thereby allowing the piston to run “dryer” and keeping oil loss at an optimal minimum.

A further advantage of the lubrication vacuum system of the present invention is the mounting of the first vacuum device on the piston. By mounting this vacuum device on the piston, the present invention is able to maintain optimal vacuum capabilities below the piston seal despite thermal expansion. While the crown of the press often reaches high temperatures, the piston typically maintains a relatively constant temperature. Therefore, mounting the vacuum device to the piston resolves inefficiencies and excessive wear due to the expansion and contraction of a crown-mounted vacuum housing.

A still further advantage of the lubrication vacuum system of the present invention is the inclined upper surface of the first vacuum device. This vacuum device is inclined such that oil drippings that land on the upper surface of the vacuum device are directed radially inwardly toward an annular opening proximally located to the piston periphery.

Another advantage of the lubrication vacuum system of the present invention is that the oil is constantly coalesced and drained off while the lubrication vacuum system is in operation, providing an environment that is easily accessed for repair without the loss of significant amounts of oil. The oil is reclaimed and routed to a press oil reservoir eliminating the need to replace lost oil.

Yet another advantage of the lubrication vacuum system of the present invention is control of the leaked oil is accomplished as long as there is a supply of air. Control and capture of oil does not depend on the total integrity of the piston seal, nor does it depend on the design or shape of the seal. Rather, oil collection only depends on the functionality of the press vacuums. This allows various seals and geometries of presses to be utilized with the invention.

A further advantage of the lubrication vacuum system of the present invention is that the amount of air flow transporting the leaked oil can be adjusted depending on the oil leakage rate. Additionally, the oil can be evacuated from the seal area in this manner to clean the seal housing before service personnel open the press for repair.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front elevational view of a mechanical press incorporating the lubrication vacuum system of the present invention;

FIG. 2 is a sectional view of one embodiment of the lubrication vacuum system as it would be applied within the crown of the press; and

FIG. 3 is a sectional view of another embodiment of the lubrication vacuum system.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

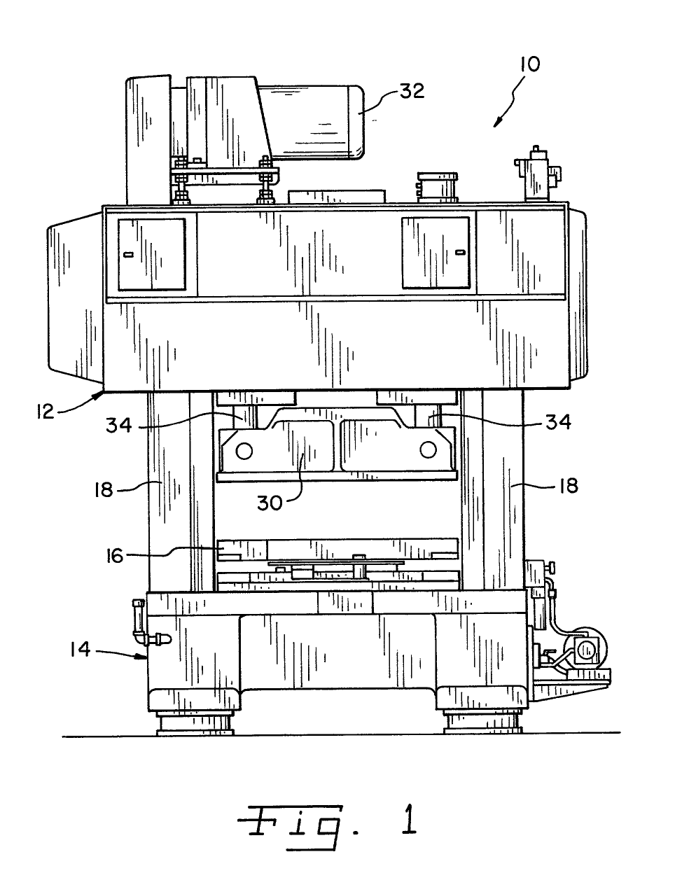

As shown in FIG. 1, a typical mechanical press 10 comprises a crown portion 12, a bed portion 14 having a bolster assembly 16 connected thereto and uprights 18 connecting crown portion 12 with bed portion 14. Uprights 18 are connected to or integral with the underside of crown 12 and the upper side of bed 14.

A slide 30 is disposed between press uprights 18 as shown in FIG. 1. Slide 30 reciprocates within press 10 by the action of main drive motor 32 attached to the top portion of crown 12. Connected to main drive motor 32 by means of a belt (not shown) and a hydraulic combination clutch/brake (not shown) is drive piston 34, which drives slide 30.

The word “piston” utilized in this application identifies generally any member that slides or reciprocates within another. Specifically, the term “drive piston” relates to the portions of slide 30 that are parallel with slide movement.

Seal members are known in the art and are used to seal about the drive piston to retain or divert lubricating oil in the event excess oil flows from the press crown. A lubrication vacuum system is also commonly used in conjunction with the seal member to generate negative pressure about the drive piston below the seal member in order to capture oil that leaks past the seal member.

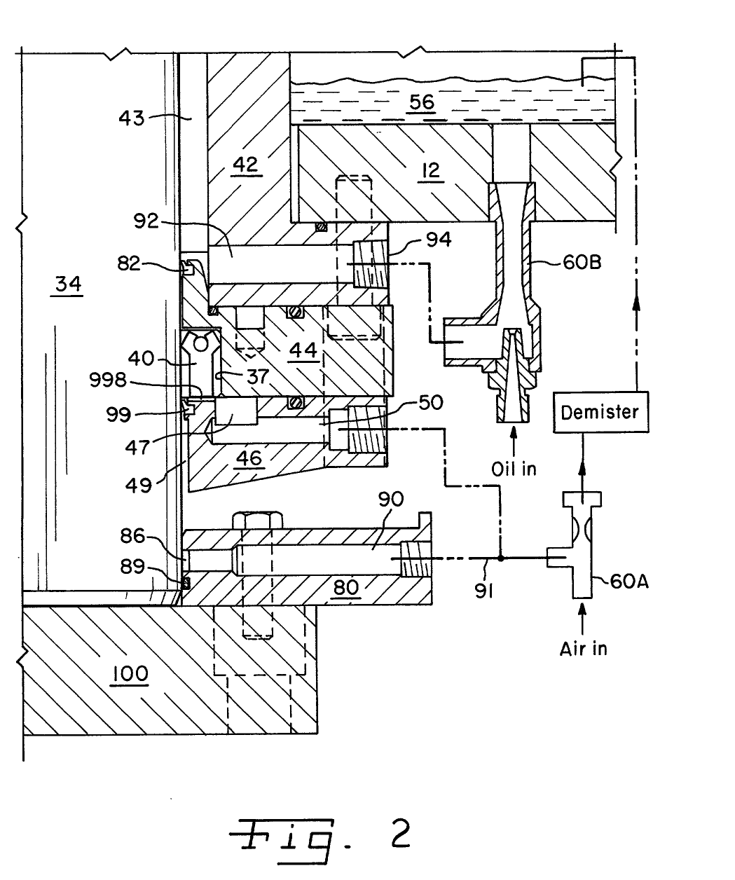

According to the present invention, and as shown in FIG. 2, a drive piston 34 is disposed for reciprocation within piston housing 42. Piston housing 42 is attached to crown 12. Located between piston housing 42 and drive piston 34 is a guide bushing 43 for maintaining adequate clearance between drive piston 34 and piston housing 42. Seal 40 seals between drive piston 34 and piston seal housing 44, and is seated in seal groove 37.

As shown in FIG. 2, a piston vacuum housing 46 is attached directly to piston seal housing 44. An annular drain port 47 is connected to conduit 50 of piston vacuum housing 46. Drain port 47 is utilized for catching leaking oil by virtue of the negative pressure created therein. Slots 998 allow for vacuuming oil from the piston side of seal 40 and wiper 99. A clearance 49 is formed between vacuum housing 46 and drive piston 34, which allows for thermal expansion of crown parts, while also allowing excess oil not captured by the vacuum system to run down the periphery of drive piston 34.

The present invention, as depicted in FIG. 2, relates to a piston-mounted vacuum housing 80 that places a negative pressure proximal to drive piston 34 to capture any oil that escapes vacuum housing 46 and runs down drive piston 34. According to the invention, vacuum housing 80 is attached to the exterior of drive piston 34, disposed between slide 100 and the piston 34, and includes an annular drain port 86 located proximal to drive piston 34. O-ring seal 89 provides a static sealing relationship between vacuum housing 80 and drive piston 34, thereby directing any oil to drain port 86. By virtue of the negative pressure created therein, drain port 86 catches leaking oil from the piston 34 and dripping oil from other press parts above. Located within vacuum housing 80 is a conduit 90 that connects to flexible conduit 91, which in turn connects to the pneumatically-driven vacuum producing mechanism 60A to be described below. Alternatively a vacuum drain as shown in U.S. Pat. No. 5,623,870 may also be utilized. During a seal leak, leaking oil will travel down the surface of drive piston 34 and be vacuumed either into drain port 47, or into drain port 86.

In one embodiment of the invention, shown also in FIG. 2, a wiper 82 connected to a seal housing 44 is further provided for minimizing the amount of oil in contact with seal 40. Seal housing 44 is secured to piston housing 42 which includes an annular drain port 92, located proximal to wiper 82. As piston 34 reciprocates, excess oil is collected from the surface of piston 34 by wiper 82, and the collected oil travels to drain port 92 and is subsequently propelled through conduit 94 by a vacuum-induced liquid flow.

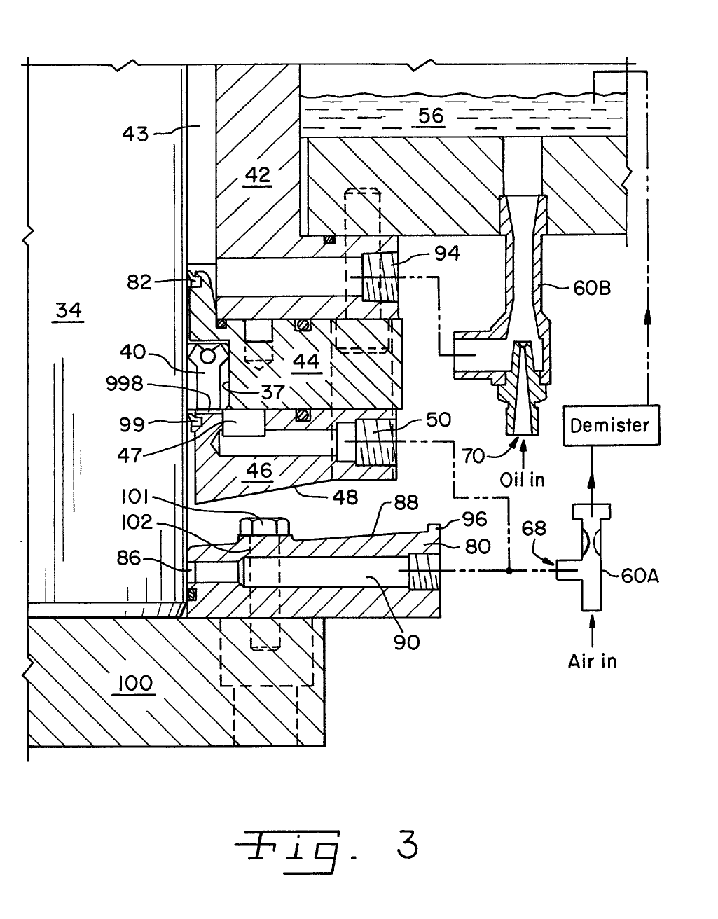

In another embodiment, depicted in FIG. 3, upper surface 88 of vacuum housing 80 is inclined. Oil drippings originating from piston 34, vacuum housing 46, seal housing 44, and piston housing 42 and elsewhere are collected by upper surface 88, and directed to drain port 86 with assistance from housing lip 96 and inclined surface 88.

Additional oil control is provided by the bottom surface 48 of vacuum housing 46. Surface 46 redirects dripping oil toward drain port 86.

By drawing off oil at two drain ports 47 and 86, located below the seal, an oil leak is kept under control for all rates of possible leakage. Furthermore, the inclined upper surface 88 of vacuum housing 80, as shown in FIG. 3, collects oil drippings from various press parts, thereby preventing contamination to stamped work pieces.

An additional wiper 49 is disposed between drain housing 46 and piston 34. Wiper 49 assists movement of oil toward drain port 47.

Oil and air are vacuumed into conduits 50 and 90 and proceed to the vacuum generator 60A as described in U.S. Pat. No. 5,623,870 and then to press oil reservoir 56. Oil vacuumed into conduit 94 by oil stream through 70 is sent directly to oil reservoir 56. The vacuum-induced air and oil flowing through conduits 50, 90, 94 can be generated by any device as is known in the art, but in the particular embodiments shown in FIGS. 2 and 3, it has been found to be most reliably and efficiently generated by a device known as an ejector or jet pump 60A air to air) or 60B (liquid to liquid).

The air flow through vacuum ejector 60A is preferably kept on at all times, even while the press 10 is not running, so as to constantly evacuate any lubricating oil leaking from about seal 40.

In operation, the invention, in one form thereof, operates substantially as follows. During press 10 operation, power from motor 32 will be conducted via a crankshaft (not shown). Rotation of the crankshaft will cause a connecting rod (not shown) to change rotational motion of the crankshaft to rectilinear reciprocating motion of drive piston 34. Seal 40 seals between reciprocating drive piston 34 and housings 44 and 46.

Referring to FIG. 3, any oil escaping past seal 40 along drive piston 34 will be caught in annular drain ports 47 and 86 connected to conduits 50 and 90. Furthermore, inclined upper surface 88 of vacuum housing 80 collects oil drippings from various press parts, further preventing contamination to stamped work pieces. Bolt 101, attaching vacuum housing 80 to slide 100, is placed in bossed receiving hole 102, so that oil does not transmit through the receiving hole 102. Finally, piston seal housing 44 is used in combination with wiper 82 to minimize the quantity of oil in contact with the piston seal 40, thereby allowing the system to run “dryer.”

Compressed air is injected into the vacuum drain as described in U.S. Pat. No. 5,623,870, whereby a venturi effect is created in ejector 60A, and a low pressure area will be developed in conduits 50, 90 connected to the vacuum drain through air inlet 68. A combination of air and oil drawn through conduits 50, 90 is now caused to flow through ejector 60A and into an oil demister assembly of U.S. Pat. No. 5,623,870 and then to reservoir 56. Oil drawn through conduit 94 is now caused to flow through ejector 60B and directly into reservoir 56.

The oil is contained in press oil reservoir 56, while the air, now substantially free from entrained oil via an oil demister filter, is allowed to pass back to the ambient atmosphere.

The amount of air flow transporting the oil can be adjusted for various leakage rates of seals 40 by opening and closing a regulator (not shown) to ejector 60A. Further, oil control is accomplished as long as there is a supply of compressed air. Oil control of the present invention does not depend on 100% integrity of the seal or the intervention of the press operator. In addition, a liquid (oil) to liquid (oil) jet pump, 60B, may be utilized to vary the suction rate at conduit 90.

The present invention, as shown in the previous embodiment, is not limited to oil control mechanisms located within the crown of a press. Depending upon the size of press 10, the required tonnage and different operating mechanisms, different locations for a lubrication vacuum system are possible.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A mechanical press having a lubricating fluid, said press comprising:
a frame;
a rod member reciprocable in said frame;
a slide actuated by said rod member;
a seal in surrounding relationship with said rod member; and
a vacuum device secured to said rod member in proximal relation to said slide for receiving excess lubricating fluid from said rod member.

2. The mechanical press of claim 1, further comprising an annular wiper in surrounding relationship with said rod member and connected to said frame, for wiping excess lubricating fluid from said rod member.

3. The mechanical press of claim 2, further comprising a second vacuum device in proximal relation to said annular wiper and connected to said frame, for receiving the lubricating fluid.

4. The mechanical press of claim 1, wherein said vacuum device further includes an inclined surface extending substantially radially outwardly from said rod member for collecting and directing the lubricating fluid.

5. The mechanical press of claim 1, wherein said vacuum device further comprises a negative pressure port adjacent said rod member for directing lubricating fluid into said vacuum device.

6. The mechanical press of claim 1, further comprising a third vacuum device adjacent to said seal and connected to said frame, for receiving excess lubricating fluid from said rod member and said seal.

7. The mechanical press of claim 1, wherein said vacuum device is further attached to said slide.

8. The mechanical press of claim 7, wherein said fastener is a bolt.

9. The mechanical press of claim 7, wherein said vacuum device includes a raised fastener receiver, said raised fastener receiver including a threaded hole.

10. A mechanical press comprising:
a frame structure with a crown and a bed;
a slide guided by the frame structure for reciprocating movement in opposed relation to said bed, said slide including a drive piston having a periphery;
a drive mechanism attached to said frame structure for driving said drive piston;
a seal about said drive piston periphery to prevent oil migration from said drive piston to said slide; and
an oil vacuum system for removing excess oil from said drive piston periphery, said system including a first vacuum device mounted to said drive piston periphery and disposed between said drive piston and said slide, and a wiper attached to said crown.

11. The press of claim 10, wherein said first vacuum device has an inclined upper surface for directing collected oil to an annular opening adjacent said drive piston periphery.

12. The press of claim 10, wherein said oil vacuum system further comprises a liquid to liquid jet pump device connected to said crown and adjacent said wiper.

13. The press of claim 10, wherein said oil vacuum system further comprises a third vacuum device.

14. A method of controlling the leakage of oil in a mechanical press, comprising the step of:
mounting a first vacuum device to a drive piston.

15. The method of claim 14, further comprising the step of inclining an upper surface of said first vacuum device for directing collected oil toward an annular opening in said first vacuum device.

16. The method of claim 14, further comprising the steps of:
mounting a wiper in surrounding relationship with said drive piston for wiping excess lubricating fluid from said drive piston; and
mounting a second vacuum device to a crown of the press in proximal relation to said wiper.

17. A mechanical press comprising:
a frame structure with a crown and a bed;
a slide guided by the frame structure for reciprocating movement in opposed relation to said bed, said slide including a drive piston having a periphery;
a drive mechanism attached to said frame structure for driving said drive piston;
a seal about said drive piston periphery for preventing oil migration from said drive piston to said slide; and
an oil vacuum system for removing excess oil from said drive piston periphery, said system including: a first vacuum device mounted to said crown and used in combination with a wiper, a second vacuum device mounted to said drive piston periphery and disposed between said drive piston and said slide, and a third vacuum device mounted adjacent said seal and connected to said crown.
